(19) United States
(12) Patent Application Publication
(10) Pub. No.: US 2002/0116992 A1
(43) Pub. Date: Aug. 29, 2002

(54) System and method for monitoring wear of a vehicle component

(75) Inventor: Carl Nelson Rickel, Novi, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/794,186

(22) Filed: Feb. 26, 2001

(51) Int. Cl. G01M 17/02

(52) U.S. Cl. 73/146

(57) ABSTRACT

A system (10) for monitoring wear of a vehicle component (12) includes a tire based unit including a transponder (20) positioned at least partially within structure of the component. The transponder (20) is positioned to undergo physical damage when the component (12) undergoes a predetermined amount of wear. The transponder (20) ceases to provide the radio frequency signal (24) when the physical damage occurs. The system (10) also includes a vehicle based unit (40) including a receiver (94) operatively connected to an electronic controller (90). The receiver (94) provides the radio frequency signal (24) to the electronic controller (90). The electronic controller (90) determines that the vehicle component (12) has undergone the predetermined amount of wear when the transponder (20) ceases providing the radio frequency signal (24).

### TECHNICAL FIELD

The present invention relates to a system and method for monitoring wear in a component of a vehicle. In one particular embodiment, the present invention relates to a system and method for monitoring tread wear on a vehicle tire.

### BACKGROUND OF THE INVENTION

It is known to monitor the wear of a vehicle component. Examples of such vehicle components are tires, brake pads, and steering/suspension components. In monitoring such vehicle components, the amount of wear is evaluated in order to determine whether the need to replace, repair or adjust the components exists. Such monitoring is typically performed via visual inspection.

Vehicle tires are monitored for signs of wear, particularly tread wear, in order to determine whether to rotate or replace the tires and also to determine whether a wheel alignment is required. Such monitoring is typically performed via visual inspection of the tires. In performing such inspections, the amount of tread wear and, more specifically, the wear pattern of the treads may be indicative of improper wheel alignment, worn or damaged steering/suspension components, improper tire inflation, or damaged or defective tires.

### SUMMARY OF THE INVENTION

In accordance with the present invention, a system for monitoring wear of a vehicle component includes a tire based unit including means for providing a radio frequency signal positioned at least partially within structure of the component. The means for providing a radio frequency signal is positioned to undergo physical damage when the component undergoes a predetermined amount of wear. The means for providing a radio frequency signal ceases to provide the radio frequency signal when the physical damage occurs.

The system also includes a vehicle based unit including means for receiving the radio frequency signal operatively connected to means for determining wear. The means for receiving the radio frequency signal provides the radio frequency signal to the means for determining wear. The means for determining wear determines that the vehicle component has undergone the predetermined amount of wear when the means for providing a radio frequency signal ceases providing the radio frequency signal.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of a system for monitoring wear of a vehicle component in accordance with an example embodiment of the present invention;

FIG. 2 is a schematic illustration of a portion of the system of FIG. 1, including portions of the vehicle structure; and

FIG. 3 is an enlarged view of a portion of the system of FIG. 2.

### DESCRIPTION OF EXAMPLE EMBODIMENTS

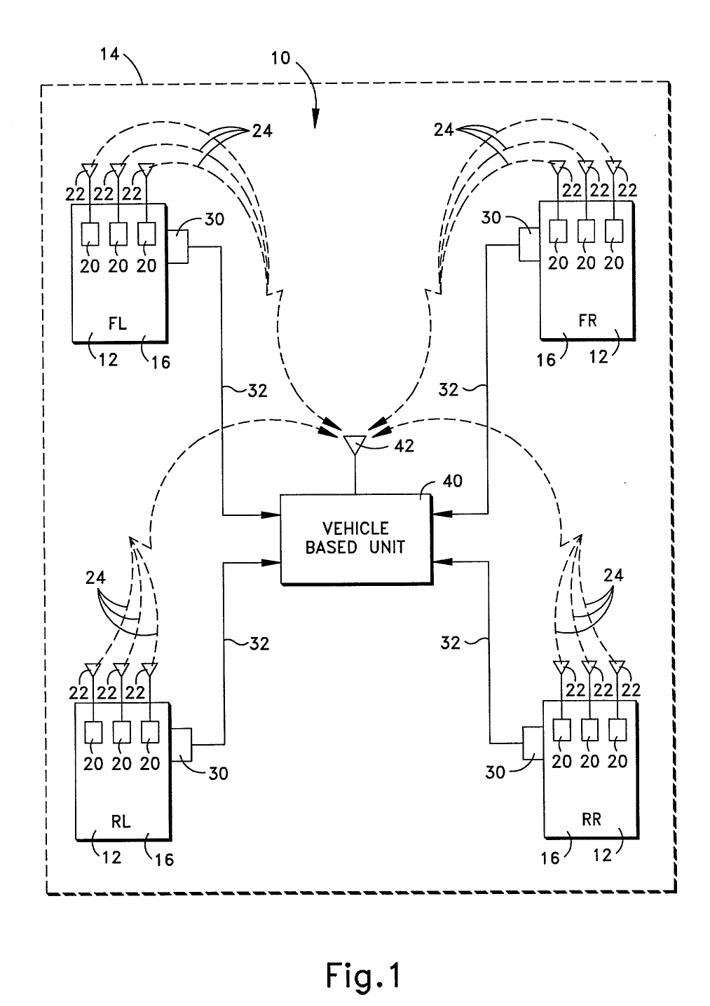

In accordance with an example embodiment of the present invention, FIG. 1 illustrates a system 10 for monitoring wear of vehicle components 12 of a vehicle 14. In the embodiment illustrated in FIG. 1, the vehicle components 12 comprise tires 16 of the vehicle 14. The vehicle 14 includes four tires 16 located at tire positions designated front-left (FL), front-right (FR), rear-left (RL) and rear-right (RR). It will be appreciated that the vehicle 14 could include more than four tires 16 or fewer than four tires.

The system 10 includes tire based units in the form of transponders 20, associated with each of the tires 16, for monitoring wear of the tires. In the embodiment illustrated in FIG. 1, each tire includes a plurality of transponders 20. According to the present invention, however, each tire 16 may include one or more transponders 20. Each transponder 20 comprises a passive antenna 22 for transmitting a radio frequency signal.

Each transponder 20 has a unique identification code that is included in every transmission of the radio frequency signal. The radio frequency signals are indicated generally by the dashed lines labeled 24 in FIG. 1. The transponders 20 provide the radio frequency signal 24 to a vehicle based unit 40 of the system 10. The vehicle based unit 40 includes an antenna 42 for receiving the radio frequency signals 24 from the transponders 20.

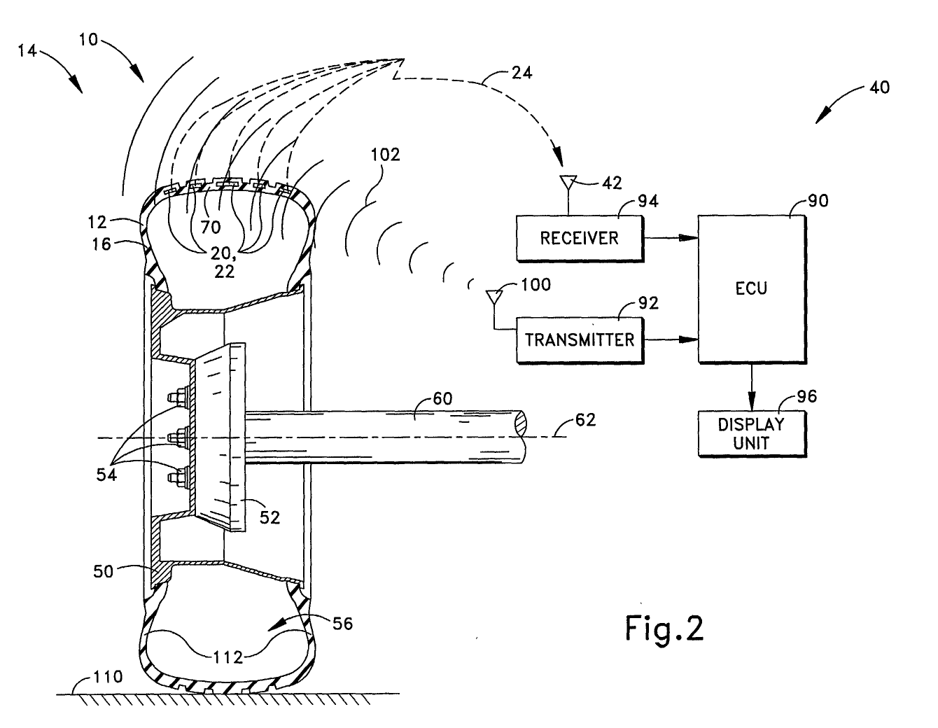

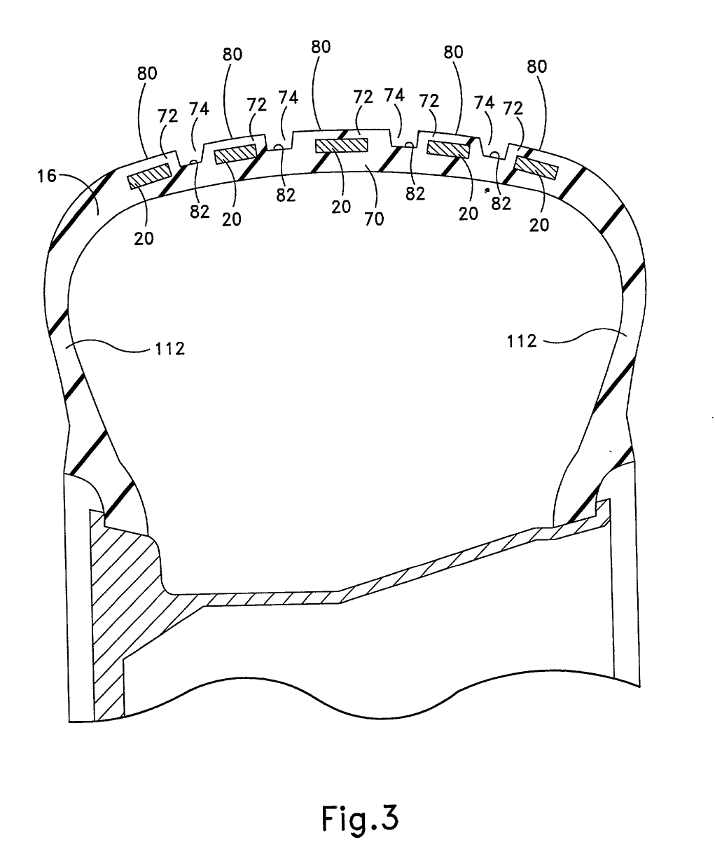

FIGS. 2 and 3 illustrate the configuration of the system 10 relative to a single tire 16 of the vehicle 14. It should be understood, however, that the configuration of the system 10 with respect to all of the vehicle tires 16 is generally identical. Therefore, FIGS. 2 and 3 are representative of the configuration of the system 10 with respect to all of the tires 16.

As illustrated in FIG. 2, each tire 16 is mounted on a rim 50, which is mounted to a wheel hub 52 via fastening means 54. The wheel hub 52 is connected to an axle 60 and rotatable with the axle about an axis 62. The rim 50 and, thus, the tire 16 are rotatable with the wheel hub 52 about the axis 62. The rim 50 and the tire 16 help define a tire cavity 56 that is inflated with an inflation fluid, such as air, to a desired inflation pressure.

Referring to FIGS. 2 and 3, each tire 16 has a tread pattern 70 that extends across a width of the tire. The tread pattern 70 includes a plurality of tread elements 72 (FIG. 3) and a plurality of tread grooves 74 spaced across a width of the tread pattern. The tread pattern 70 has a tread depth defined by the distance from an upper surface 80 of the tread element to a bottom surface 82 of an adjacent tread groove 74. This same measurement may also be referred to as the height of a tread element 72 or the depth of a tread groove 74.

As best illustrated in FIG. 3, the transponders 20 are embedded within the structure of the tread elements 72. Preferably, the transponders 20 are embedded in the tread elements 72 during manufacture of the tires 16, such as by molding the tread elements around the transponders.

Each transponder 20 is associated with an individual tread element 72. The transponders 20 are thus spaced across the width of the tread pattern 70 of the tire 16. The transponders 20 are located at a predetermined position within the tread depth of the tread pattern 70. As viewed in FIG. 3, the predetermined position is located below the upper surface 80 of the tread element 72 in which the transponder is embedded and above the bottom surface 82 of the tread grooves 74 adjacent the tread element.

The predetermined position is selected such that the transponders 20 are each positioned generally the same distance below the upper surface 80 of the respective tread element 72 in which the transponder is embedded. The transponders 20 are thus positioned in general alignment with each other laterally across the width of the tread pattern 70 as viewed in FIGS. 2 and 3.

Referring to FIG. 2, the vehicle based unit 40 includes an electronic control unit (ECU) 90, transmitter 92, a receiver 94, and a display unit 96. It will be appreciated that the ECU 90 may have a variety of configurations. For example, the ECU 90 may comprise a plurality of discrete circuits, circuit components, and a controller. The ECU 90 could have various alternative configurations that include combinations of digital and/or analog circuitry.

The transmitter 92 is operatively connected to the ECU 96 and is operable to provide a radio frequency interrogation signal via an antenna 100. The interrogation signal is indicated generally at 102 in FIG. 2. The transmitter 92 is operable to provide the interrogation signal 102 upon command by the ECU 90.

The receiver 94 is operatively connected to the ECU 90 and receives the radio frequency radio frequency signals 24 from the transponders 20 via the antenna 42. The receiver 94 is operable to provide the radio frequency signal 24 to the ECU 90.

The passive antenna 22 of each transponder is of a known construction designed to resonate when acted on by a radio frequency signal. During operation of the system 10, the ECU 90 commands the transmitter 92 to transmit the interrogation signal 100. The interrogation signal 100 acts on the transponders 20, which causes the passive antenna 22 to resonate and provide the radio frequency signal 24 in response to the interrogation signal. The radio frequency signal 24 provided by each transponder 20 is modulated to include the unique identification code of the transponder.

The receiver 94 receives the radio frequency signal 24 from each of the transponders 20 and provides the radio frequency signal to the ECU 90. The ECU 90 demodulates the radio frequency signals 24 to obtain the identification codes received in response to transmission of the interrogation signal 100. It will be appreciated, however, that demodulation could take place in the receiver 94, in which case the identification codes would be provided to the ECU 90 by the receiver.

During use of the tire 16, the tread pattern 70 will experience tread wear, which causes the tread elements 72 to gradually wear down, thus reducing the tread depth. Ideally, the tread pattern 70 will wear evenly during use of the tire 16, and thus the tread pattern will have a uniform tread depth across the width of the tire. It will be appreciated, however, that the tire 16 may not wear evenly across the tread pattern 70. Such uneven wear may be indicative of the need to rotate or replace the vehicle tires 16, improper wheel alignment, or worn steering/suspension components, such as tie rods or stabilizer bars.

As the tread elements 72 wear down, the upper surfaces 80 of the elements move closer to the respective transponders 20 embedded in the tread elements. Eventually, the tread elements 72 wear down to the predetermined position where the transponders 20 are positioned. At this point, the transponders 20 are exposed to the surface 110 upon which the vehicle 14 is traveling. Contact with the surface 110 causes structural damage to the transponders 20. As a result, the transponders cease transmitting the radio frequency signals 24. Thus, the occurrence of a transponder 20 ceasing to transmit the radio frequency signal 24 indicates that the tread element 72 in which the transponder is embedded has worn down to the predetermined position.

The system 10 monitors tread wear by demanding the interrogation signals 102 and monitoring which of the radio frequency signals 24 are returned by the transponders 20. The identification codes of the transponders 20 are arranged in a predetermined protocol. The protocol is such that the radio frequency signal 24 of each transponder 20 may be readily associated as being one of a group of transponders in a particular tire 16 and also as being embedded in a particular position along the tread pattern 70 of that particular tire.

To this end, the identification code of each transponder 20 includes a tire identifier portion common to all of the transponders of any given tire 16. For example, the tire identifier portion of the identification code may comprise a serial number common to all of the transponders 20 embedded in a given tire 16. The identification code of each transponder 20 also includes a tread element identifier indicative of the position of the respective tread element 72 in the tread pattern 70. For example, the tread element identifier portion may indicate the position of the respective tread element 72 relative to a particular sidewall 112 of the tire 16.

The system 10 is thus operable to monitor tread wear of the tread elements 72 across the tread pattern 70 of each tire 16. The ECU 90 evaluates the data provided by the transponders 20 to determine the wear pattern of the tread pattern 70 of each of the vehicle tires 16.

The vehicle based unit 40 includes means for associating the transponders 20 of each tire 16 with the tire position (FL, FR, RL, RR) on the vehicle 14 where the tire is mounted. Preferably, the vehicle based unit 40 includes a receiver 92 specific to each tire position on the vehicle 14. Thus, the vehicle 14 illustrated in FIGS. 1-3 would include four receivers 92. The receivers 92 would be mounted at or near each of the respective tire positions. For example, the receivers 92 could be mounted in a wheel well (not shown) adjacent each tire 16. In this configuration, the vehicle based unit 40 could also include individual transmitters 94 positioned adjacent the tires 16 with the receivers 92, or the vehicle based unit could include a single central transmitter.

The individual receivers 92 are operatively connected to the ECU 90, such as by unique radio frequency signal or by hard wiring. Thus, the respective tire position of each receiver 92 is associated with the radio frequency signal 24 provided to the ECU 90 by the receiver. The system 10 would associate the wear patterns of the tread patterns 70 with specific tire positions on the vehicle 14 automatically. Thus, the system 10 would not require calibration or programming to learn the tire position associated with each of the transponders 20.

In an alternative configuration of the system 10, the ECU 90 may include means, such as a look-up table, for correlating the transponder identification codes with the particular tire position that the tire 16 is mounted on the vehicle 14. This would require programming or calibration of the system 10 in order to provide the ECU 90 with the identification codes of the transponders 20 and their respective tire position on the vehicle 14.

Accordingly, the identification code of each transponder 20 is attributed to a specific tire position on the vehicle 14. The system 10 monitors the wear pattern of the tread pattern 70 of each tire and associates the wear pattern with the tire position on the vehicle 14 from which the wear pattern is sensed. This information can thus be used to alert or otherwise indicate that tire replacement, rotation or wheel alignment is necessary. This information may also be indicative of wear in other vehicle components, such as steering/suspension components.

The ECU 90 is operatively connected to the display unit 96. The display unit 96 provides indication of the monitored wear pattern of the tread pattern 70 of each tire position on the vehicle 14. Such indications may be in the form visual devices (e.g., display screens or indicator lights) and/or audible devices (e.g., buzzers or chimes). The system 10 could also provide tire wear data to vehicle diagnostic equipment (not shown) commonly used at vehicle repair facilities.

It will be appreciated that the configuration of the system 10 may vary from the example embodiment illustrated in FIGS. 1-3 without departing from the spirit of the present invention. For example, in the example embodiment, the transponders 20 are illustrated as being positioned laterally across a portion of the circumference of the tread pattern 70. The transponders 20 could, however, be staggered along the circumference of the tread pattern 70 or could even extend around the entire circumference of the tread pattern.

Also, in the example embodiment, the transponders 20 are configured to monitor when the respective tread elements 72 wear down to a single predetermined position. The transponders 20 could, however, be placed in layers within the tread elements 72 and thereby provide indication that the tread elements wear down to a plurality of predetermined positions. This may help to provide a higher resolution or more accurate determination of the wear pattern of the tread pattern 70 of the tires 16.

Furthermore, although the example embodiment of the present invention has been illustrated as monitoring wear of a vehicle tire, it will be appreciated that the present invention may be used to monitor wear of other vehicle components. For example, the transponders could be embedded within structure of vehicle brake pads or a belt, such as a serpentine belt. The system would thus be operable to monitor the wear of the brake pads or belt in a manner as described herein above.

From the above description of the invention, those skilled in the art will perceive improvements, changes and modifications. Such improvements, changes and modifications within the skill of the art are intended to be covered by the appended claims.

Having described the invention, the following is claimed:

1. A system for monitoring wear of a vehicle component, said system comprising:
a tire based unit including means for providing a radio frequency signal, said means for providing a radio frequency signal being positioned at least partially within structure of said component and being positioned to undergo physical damage when said component undergoes a predetermined amount of wear, said means for providing a radio frequency signal ceasing to provide said radio frequency signal when the physical damage occurs; and
a vehicle based unit including means for receiving said radio frequency signal and means for determining wear of the vehicle component, said means for receiving being operatively connected to said means for determining wear to provide said radio frequency signal to said means for determining wear, said means for determining wear determining that the vehicle component has undergone the predetermined amount of wear when said means for providing a radio frequency signal ceases providing said radio frequency signal.

2. The system as defined in claim 1, wherein said means for providing said radio frequency signal comprises at least one transponder, said vehicle based unit further including means for providing an interrogation signal that acts on said at least one transponder, said at least one transponder resonating to provide said radio frequency signal when said interrogation signal acts on said at least one transponder.

3. The system as defined in claim 2, wherein said at least one transponder resonates at a predetermined frequency when said interrogation signal acts on said at least one transponder, said at least one transponder providing said radio frequency signal at said predetermined frequency.

4. The system as defined in claim 3, wherein said vehicle component comprises a tire having a tread pattern at least partially defined by a plurality tread elements and tread grooves spaced across a width of said tread pattern, said at least one transponder being embedded in at least one of said tread elements at a predetermined position in said at least one tread element, said at least one transponder undergoing physical damage and ceasing to provide said radio frequency signal when said at least one tread element undergoes said predetermined amount of wear.

5. The system as defined in claim 4,wherein said at least one transponder comprises a plurality of transponders embedded in respective ones of said plurality of said tread elements and spaced across said width of said tread pattern, said means for determining wear determining a wear pattern of the tread pattern of the tire based upon which of said plurality of transponders provides said radio frequency signal and which of said plurality of transponders do not provide said radio frequency signal when said interrogation signal acts on said plurality of transponders.

6. The system as defined in claim 5, wherein each of said plurality of transponders provides a unique identification code in said radio frequency signal, said means for determining wear determining said wear pattern based upon which of said identification codes are received by said means for receiving and which of said identification codes are not received by said means for receiving when said interrogation signal acts on said plurality of transponders.

7. The system as defined in claim 6, wherein said means for receiving comprises a receiver operatively connected to said means for determining wear, said receiver being associated with a known tire position on the vehicle and providing said identification code and the tire position from which said identification code is received to said means for determining wear, said means for determining associating said wear pattern with the tire position from which said identification code is received.

8. A system for monitoring wear of a vehicle tire having a tread pattern and a plurality of tread elements spaced across a width of the tread pattern, said system comprising:
at least one transponder positioned at least partially within the structure of at least one of the tread elements at a predetermined position in the at least one tread element; and
a vehicle based unit including means for providing an interrogation signal that acts on said at least one transponder, said at least one transponder transmitting a radio frequency signal when acted on by said interrogation signal, said vehicle based unit further including means for receiving said radio frequency signal and means for determining wear based on the received radio frequency signal, said at least one transponder undergoing physical damage when the at least one tread element wears down to said predetermined position, the physical damage causing said at least one transponder to cease transmitting said radio frequency signal when acted on by said interrogation signal, said means for determining wear determining that the at least one tread element has worn down to said predetermined position when said means for receiving said radio frequency signal ceases receiving said radio frequency signal.

9. A system for monitoring a wear pattern of a tread pattern of a vehicle tire, said tread pattern having a plurality of tread elements spaced across a width of the tread pattern, said system comprising:
a plurality of transponders positioned within the structure of respective ones of the tread elements at a predetermined position in the tread elements;
a transmitter for providing an interrogation signal that acts on said transponders, said transponders resonating to transmit radio frequency signals when acted on by said interrogation signal;
a receiver for receiving said radio frequency signals, said receiver being associated with a known tire position of the tire on the vehicle; and
means for determining a wear pattern of the tread pattern, said means for determining a wear pattern being operatively connected to said receiver, said receiver providing said radio frequency signal to said means for determining a wear pattern,
said transponders undergoing physical damage when respective tread elements wear down to said predetermined position, the physical damage causing said transponders to cease transmitting said radio frequency signal when acted on by said interrogation signal, said means for determining a wear pattern determining that a tread element has worn down to said predetermined position when the transponder embedded in the tread element ceases transmitting said radio frequency signal.

10. A method for monitoring wear of a vehicle component, said method comprising the steps of:
positioning means for providing a radio frequency signal at least partially within the structure of the vehicle component, said means for providing a radio frequency signal undergoing physical damage when said component undergoes a predetermined amount of wear, said physical damage causing said means for providing a radio frequency signal to cease providing said signal;
monitoring said radio frequency signal to determine when said means for providing said radio frequency signal ceases providing said radio frequency signal; and
determining that said vehicle component has undergone a predetermined amount of wear when said means for providing said radio frequency signal ceases providing said radio frequency signal.

11. A method for monitoring wear of a vehicle tire having a tread pattern including tread elements spaced across a width of the tread pattern, said method comprising the steps of:
positioning at least one transponder at least partially within the structure of at least one tread element at a predetermined position in the at least one tread element;
providing an interrogation signal that acts on said at least one transponder, said at least one transponder transmitting a radio frequency signal when acted on by said interrogation signal, said transponder ceasing to provide said radio frequency signal when the at least one tread element wears down to said predetermined position;
monitoring said radio frequency signal to determine when said at least one transponder ceases providing said radio frequency signal; and
determining that the at least one tread element has worn down to said predetermined position when said at least one transponder ceases providing said radio frequency signal.

12. A method for monitoring a wear pattern of a vehicle tire having a tread pattern including tread elements spaced across a width of the tread pattern, said method comprising the steps of:
positioning a plurality of transponders at least partially within structure of respective tread elements at a predetermined position in the respective tread elements, said transponders thereby being spaced across the width of the tread pattern;
providing an interrogation signal that acts on said transponders, each of said transponders transmitting a unique radio frequency signal when acted on by said interrogation signal, said transponders ceasing to provide said radio frequency signal when the respective tread elements wear down to said predetermined position;
monitoring said radio frequency signals to determine when said transponders cease providing said radio frequency signal; and
determining which of the respective tread elements have worn down to said predetermined position by determining when said transponders cease providing said radio frequency signal.

13. The method as defined in claim 1, further comprising the step of determining which of said radio frequency signals have ceased providing said radio frequency signal to determine a wear pattern of the tread pattern.
